(19) United States
(12) Patent Application Publication
(10) Pub. No.: US 2025/0317926 A1
(43) Pub. Date: Oct. 9, 2025

(54) UPLINK CARRIER PRIORITIZATION

(71) Applicant: InterDigital Patent Holdings, Inc., Wilmington, DE (US)

(72) Inventors: Paul Marinier, Brossard (CA); Virgil Comsa, Montreal (CA); Faris Alfarhan, Montreal (CA); Aata El Hamss, Laval (CA); Moon-il Lee, Melville, NY (US); Janet A. Stern-Berkowitz, Little Neck, NY (US)

(73) Assignee: InterDigital Patent Holdings, Inc., Wilmington, DE (US)

(21) Appl. No.: 18/860,483

(22) PCT Filed: Apr. 27, 2023
(86) PCT No.: PCT/US2023/020155

§ 371 Date: Oct. 25, 2024

Related U.S. Application Data
(60) Provisional application No. 63/335,441, filed on Apr. 27, 2022.

(51) Int. Cl. H04W 72/1268; H04L 5/00; H04W 72/232

(52) U.S. Cl. CPC H04W 72/1268; H04L 5/001; H04W 72/232

(57) ABSTRACT

Systems, methods, and instrumentalities are described herein associated with prioritizing among uplink carriers and/or uplink transmissions. A maximum number of carrier(s) may be prioritized for transmission at a transmission time. The determination of which carrier(s) to prioritize may be based on a cell type the carrier(s) are associated with and/or may be based on when UL grant DCI(s) are received on the associated carrier(s) (e.g., relative to a transmission time to when other UL grant DCI(s) are received). The WTRU may transmit a respective physical uplink shared channel (RUSCH) transmission, via each prioritized carrier, using resource(s) associated with the respective CG of each prioritized carrier.

### CROSS-REFERENCE TO RELATED APPLICATIONS

This application claims the benefit of Provisional U.S. Patent Application No. 63/335,441, filed Apr. 27, 2022, the disclosure of which is incorporated herein by reference in its entirety.

### BACKGROUND

Wireless communications may be performed using multiple carriers such as multiple uplink carriers. A transmission switching scheme may be implemented across multiple bands and the number of bands may exceed the number of simultaneous transmissions a device is capable of performing. Systems and methods for improving the use of multiple carriers may be desired.

### SUMMARY

Systems, methods, and instrumentalities are described herein associated with prioritizing among uplink carriers and/or uplink transmissions.

A wireless transit/receive unit (WTRU) may receive configuration information indicating a number of configured grants (CGs). The number of CGs may include a first CG associated with a first cell and a first carrier, a second CG associated with a second cell and a second carrier, a third CG associated with the second cell and a third carrier, and a fourth CG associated with the second cell and a fourth carrier. The WTRU may receive a first physical downlink control channel (PDCCH) transmission carrying a first uplink (UL) grant downlink control information (DCI) associated with the second carrier and may receive a second PDCCH transmission carrying a second UL grant DCI associated with the third carrier.

A maximum number of carrier(s) may be prioritized for transmission at a transmission time. The determination of which carrier(s) to prioritize may be based on a cell type the carrier(s) are associated with and/or may be based on when UL grant DCI(s) are received on the associated carrier(s) (e.g., relative to a transmission time to when other UL grant DCI(s) are received). The WTRU may transmit a respective physical uplink shared channel (PUSCH) transmission, via each prioritized carrier, using resource(s) associated with the respective CG of each prioritized carrier.

In examples, the WTRU may determine to prioritize the first carrier and the third carrier for a transmission at a first transmission time. The determination to prioritize the first carrier may be based on the first cell type being a primary cell (PCell) type and the determination to prioritize the second carrier may based on the second UL grant DCI being the last DCI received before the first transmission time. At the first transmission time, the WTRU may transmit, via the first carrier, a first PUSCH transmission using resource(s) associated with the first CG and may transmit, via the third carrier, a second PUSCH transmission using resource(s) associated with the third CG.

In examples, the WTRU may determine to prioritize the second carrier and the third carrier for a transmission at a second transmission time. The determination to prioritize the second carrier and the third carrier for the second transmission time may be based on the first UL grant DCI received on the second carrier and the second UL grant DCI received on the third carrier being the last two DCIs received before the second transmission time. At the second transmission time, the WTRU may transmit, via the second carrier, a third PUSCH transmission using resource(s) associated with the second CG and may transmit, via the third carrier, a fourth PUSCH transmission using resources(s) associated with the third CG.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example of uplink carrier prioritization.

### DETAILED DESCRIPTION

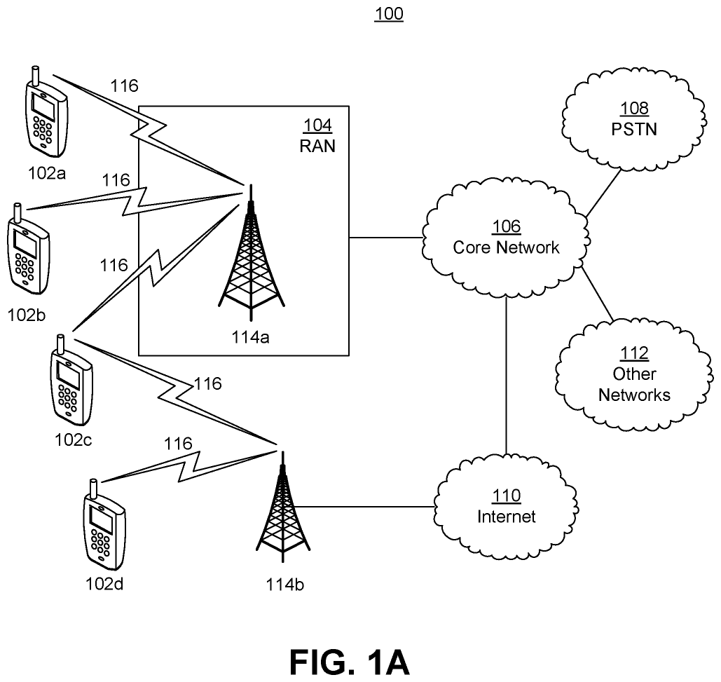

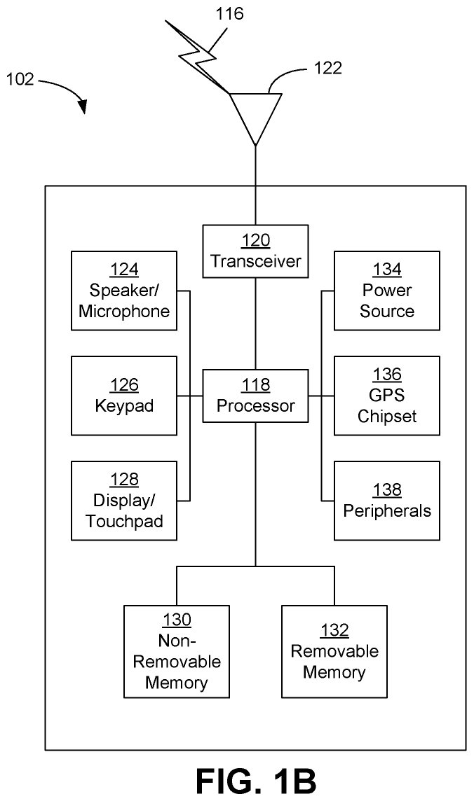

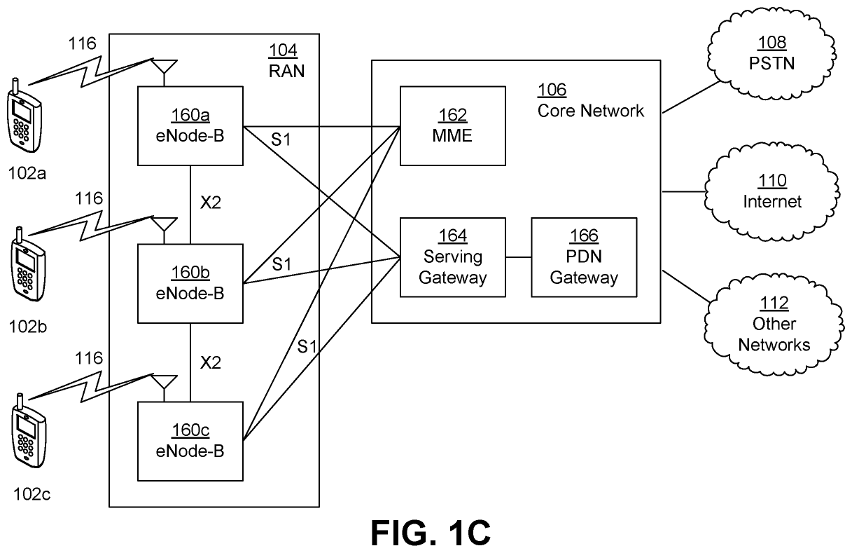

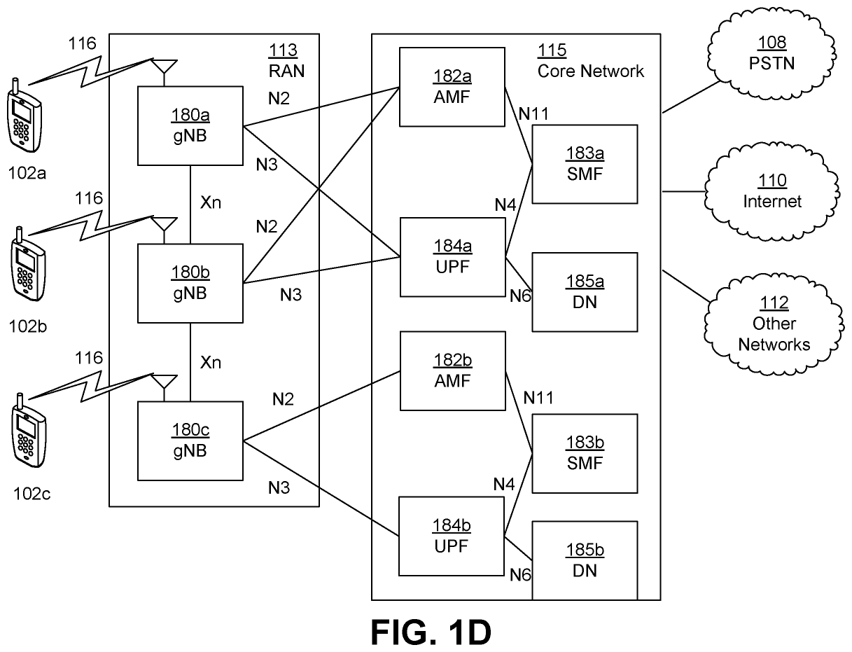

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to determination of a time or determination of a period of time. Reference to a timer expiration herein may refer to determining that the time has occurred or that the period of time has expired. Reference to a timer herein may refer to a time, a time period, tracking the time, tracking the period of time, etc. Reference to a legacy technology or legacy handover, may indicate a legacy technology such as LTE compared to NR, or, a legacy version of a technology, for example an earlier version/release of a technology (e.g., earlier NR release) compared to a later version/release of the technology (e.g., later NR release).

Systems, methods, and instrumentalities are described herein associated with prioritizing among uplink carriers and/or uplink transmissions.

A WTRU may receive configuration information indicating a number of configured grants (CGs). The number of CGs may include a first CG associated with a first cell and a first carrier, a second CG associated with a second cell and a second carrier, a third CG associated with the second cell and a third carrier, and a fourth CG associated with the second cell and a fourth carrier. The WTRU may receive a first physical downlink control channel (PDCCH) transmission carrying a first uplink (UL) grant downlink control information (DCI) associated with the second carrier and may receive a second PDCCH transmission carrying a second UL grant DCI associated with the third carrier.

A maximum number of carrier(s) may be prioritized for transmission at a transmission time. The determination of which carrier(s) to prioritize may be based on a cell type the carrier(s) are associated with and/or may be based on when UL grant DCI(s) are received on the associated carrier(s) (e.g., relative to a transmission time). The WTRU may transmit a respective physical uplink shared channel (PUSCH) transmission, via each prioritized carrier, using resource(s) associated with the respective CG of each prioritized carrier.

In examples, the WTRU may determine to prioritize the first carrier and the third carrier for a transmission at a first transmission time. The determination to prioritize the first carrier may be based on the first cell type being a primary cell (PCell) type and the determination to prioritize the second carrier may based on the second UL grant DCI being the last DCI received before the first transmission time. At the first transmission time, the WTRU may transmit, via the first carrier, a first PUSCH transmission using resource(s) associated with the first CG and may transmit, via the third carrier, a second PUSCH transmission using resource(s) associated with the third CG.

In examples, the WTRU may determine to prioritize the second carrier and the third carrier for a transmission at a second transmission time. The determination to prioritize the second carrier and the third carrier for the second transmission time may be based on the first UL grant DCI received on the second carrier and the second UL grant DCI received on the third carrier being the last two DCIs received before the second transmission time. At the second transmission time, the WTRU may transmit, via the second carrier, a third PUSCH transmission using resource(s) associated with the second CG and may transmit, via the third carrier, a fourth PUSCH transmission using resources(s) associated with the third CG.

In examples, a WTRU may prioritize a first scheduled UL transmission over a second scheduled uplink transmission (e.g., the WTRU may send the first scheduled uplink transmission and may not send the second scheduled uplink transmission). In examples, a WTRU may choose which scheduled UL transmission(s) to send based on an order indicated in a set of uplink carriers (e.g., the uplink carriers in the set may be associated with different priorities and may be sent or not sent based on those priorities). A WTRU may be configured to operate with more uplink carriers that cause the WTRU to exceed its maximum simultaneous transmission capability. The WTRU may (e.g., in such as case) prioritize uplink carriers according to a prioritized set. The prioritized set may be determined based on reception of a latest DCI (e.g., relative to a transmission time) for an uplink carrier, a power headroom, explicit signaling, and/or an amount of data that may be transmitted. The WTRU may trigger a power headroom report if updating a prioritized set of uplink carriers. The WTRU may deactivate (e.g., implicitly) a configured grant on a deprioritized uplink carrier. The WTRU may receive signaling regarding an uplink dormant BWP for at least one UL carrier.

A scheduler may ensure (e.g., for at least dynamically allocated resources such as dynamic grants, aperiodic sounding reference signals (SRS), etc.) that the simultaneous transmission capability of a WTRU is not exceeded (e.g., at any time) by avoiding overlap between transmissions (e.g., scheduled transmissions) that may exceed the capability. A network may configure resources semi-statically. Such resources may include periodic SRS, configured grants, periodic channel state information (CSI) reports, etc. If these resources are requested, it may be restrictive for the network to avoid scheduling the resources in such a way that the simultaneous transmission capability of a WTRU is not exceeded (e.g., at any time) (e.g., if considering minimum switching times and/or possibly different time division duplex (TDD) UL/DL configurations between bands). The resources may be allowed to overlap (e.g., in the time domain) in such a way that they may exceed the simultaneous transmission capability of a WTRU. If this happens, prioritization of transmissions (e.g., scheduled uplink transmissions) may be allowed.

A WTRU may prioritize transmissions if resources configured or scheduled may exceed the simultaneous transmission capability of the WTRU (e.g., over an interval of time). In examples, a WTRU may be capable of transmitting up to M simultaneous transmissions over one or more (e.g., all) uplink carriers (e.g., the uplink carriers may be in different frequency bands and/or a K-port transmission on a carrier may be considered as K transmissions) and the WTRU may be configured with N uplink carriers. The N uplink carriers may correspond to serving cells and may include supplementary uplink carriers in certain serving cells. The WTRU may indicate (e.g., via uplink signaling) its simultaneous transmission capability to a network. The WTRU may signal its transmission power (e.g., maximum transmission power) per carrier and/or as a total of multiple carriers if the WTRU transmits on a combination of carriers on specific bands.

A minimum switching time (MST) may be set and/or enforced if a WTRU changes the set of uplink carriers over which the WTRU transmits. The MST (e.g., if the WTRU switches transmission from a first carrier to a second carrier) may depend on at least the carrier frequency and/or band of the first carrier and/or the second carrier.

A WTRU may receive radio resource control (RRC), medium access control (MAC), and/or downlink control information (DCI) signaling that may configure or indicate a set of uplink transmissions and/or uplink grants on N carriers. The uplink transmissions and/or uplink grants may be associated with at least one of a physical uplink control channel (PUCCH), a physical uplink shared channel (PUSCH), a sounding reference signal (SRS), or a physical random access channel (PRACH). If a set of uplink transmissions and/or uplink grants exceed the WTRU's simultaneous uplink transmission capability (e.g., over any duration), the WTRU may perform prioritization of the uplink transmissions and/or uplink grants such that its capability is not exceeded. To determine whether simultaneous uplink transmission capability may be exceeded at a given time, one or more of the following may be applied: the start time of an uplink transmission or grant may be assumed to be up to an MST before the actual start time of the transmission or grant (e.g., to account for the MST) (e.g., if there is no preceding uplink transmission on the same carrier); or a K-port transmission on an uplink carrier may count as K transmissions out of M maximum simultaneous transmissions.

At least in the case of PUSCH transmissions, prioritization may be performed at a MAC sublayer. If prioritization is performed at a MAC sublayer, a WTRU may perform logical channel prioritization and/or may generate a corresponding MAC packet data unit (PDU) for (e.g., only for) uplink grants that are prioritized.

Prioritization may be performed at a physical layer for transmissions other than PUSCH transmissions or for PUSCH transmissions (e.g., in case prioritization occurs as a result of receiving dynamic signaling after a latest time prior to the start of an earliest overlapping transmission). The difference between the latest time and the start time of an earliest overlapping transmission may correspond to a processing capability of the WTRU. In examples, a WTRU may cancel a transmission if the WTRU does not perform the transmission due to de-prioritization (e.g., at a MAC layer or a PHY layer).

Prioritization may be performed in accordance with one or more of the following: dynamically on a per-transmission basis; semi-dynamically with a prioritized set of carriers or dormant UL bandwidth part (BWP); a dormant UL BWP; an application time of a prioritized set; a modification of a prioritized set; valid prioritized sets; or actions if updating a prioritized set.

For prioritization performed dynamically on a per-transmission basis, a WTRU may perform prioritization by de-prioritizing individual transmissions until the maximum simultaneous transmission capability of the WTRU is not exceeded. The WTRU may determine and cancel a first transmission among overlapping transmissions that has a lowest priority. If the maximum simultaneous transmission capability is still exceeded after cancellation of this transmission, the WTRU may cancel a second transmission that has a lowest priority among the remaining overlapping transmissions, and so on until the maximum simultaneous transmission capability is not exceeded.

For prioritization performed semi-dynamically with a prioritized set of carriers or a dormant uplink BWP, a WTRU may determine a priority order between uplink carriers. Such a priority order may be referred to herein as a prioritized set, which may be an ordered set. The WTRU may perform transmissions on (e.g., only on) the UL carriers that are part of the prioritized set at a given time. In case the maximum simultaneous transmission capability of the WTRU may be exceeded (e.g., even with only the UL carriers that are part of the prioritized set), the WTRU may cancel transmissions over UL carriers of the lowest priority until the simultaneous transmission capability is not exceeded. The WTRU may determine an initial prioritized set using pre-determined rules and/or based on signaling from a network. In examples, a prioritized set may indicate (e.g., for each carrier) a maximum number of antenna ports.

For a dormant UL BWP, a WTRU may receive configuration information regarding a dormant UL BWP (e.g., for at least one serving cell). The dormant UL BWP may be such that no uplink resources are configured (e.g., semi-statically configured) for the dormant UL BWP. The WTRU may receive a DCI including a bitmap where each bit may correspond to an uplink carrier, a corresponding serving cell, a group of uplink carriers, or corresponding serving cells. Such a bitmap may be referred to herein as an UL special cell (SpCell) dormancy field. The group of uplink carriers or serving cells may be configured by RRC signaling.

A WTRU may include an uplink carrier (or a group thereof) in a prioritized set if a corresponding bit in a DCI (e.g., a DCI described herein) (e.g., in the UL secondary cell (SCell) dormancy field of the DCI) is set to a first value (e.g., for a non-dormant UL BWP). The WTRU may exclude an uplink (or a group thereof) from the prioritized set if the corresponding bit in the DCI is set to a second value (e.g., for a dormant UL BWP).

A WTRU may utilize the same field used for indicating SCell dormancy for a downlink (DL). The WTRU may receive an indication of whether to interpret the indications in the bitmap (e.g., as described herein) as indicating SCell dormancy for a DL (e.g., a dormant or non-dormant DL BWP for a SCell), as indicating SCell dormancy for an UL (e.g., a dormant or non-dormant UL BWP for a SCell), or both. Such an indication may be present for a specific DCI format such format 2_6 or another format. The WTRU may interpret the bitmap as indicating SCell dormancy for a DL if the bitmap is received in a DCI format scheduling PDSCH (e.g., format 1_1 or 1_2). The WTRU may interpret the bitmap as indicating SCell dormancy for an UL if the bitmap is received in a DCI format scheduling PUSCH (e.g., format 0_1 or 0_2).

A WTRU may utilize the same type of signaling as for SCell dormancy to indicate whether a UL carrier is part of a prioritized set or not (e.g., without implying that the WTRU switches to a dormant UL BWP for an uplink carrier indicated as not being part of the prioritized set). The WTRU may receive a DCI and the DCI may include information on an UL BWP or a dormant UL BWP for more than one serving cell or carrier. In examples, the DCI may include a field including a bitmap, where each bit or group of bits of the bitmap may indicate which UL BWP to use (e.g., such as whether to use a dormant UL BWP or other UL BWP) for a (e.g., each) configured serving cell or uplink carrier. In examples, the DCI may include a field that indicates one of a set of values signaled by a MAC control element (MAC CE) or an RRC message, where each value may indicate an UL BWP (or a dormant UL BWP) for each serving cell or uplink carrier.

For the application time of a prioritized set, a WTRU may modify a prioritized set when certain events occur or according to a certain schedule (e.g., as described herein). In examples, a prioritized set may be fixed over a specific period of time referred to herein as an application period. An application period may include a set of symbols, a slot, a set of slots, a frame, or a set of frames. The WTRU may re-evaluate the prioritized set before application periods (e.g., each application period). The application period may depend on a TDD UL/DL configuration (e.g., which may be indicated semi-statically) and/or a slot configuration (e.g., which may be indicated semi-statically or dynamically). In examples, application periods (e.g., each application period) may correspond to a set of consecutive uplink symbols. An application period may be subject to one or more of the following constraints: all repetitions of a PUSCH may be included within an application period; a configured time window for joint channel estimation may be included within an application period; or all retransmissions of a transport block (TB) for a given hybrid automatic repeat request (HARQ) process may be included within an application period. For at least a TDD serving cell, an uplink carrier may (e.g., implicitly) be excluded from a prioritized set during time symbols identified as downlink symbols.

For a modification of a prioritized set, a prioritized set may be modified or updated if receiving RRC signaling, a MAC CE, or DCI signaling. A WTRU may receive an indication (e.g., an explicit indication) of a prioritized set via RRC signaling, a MAC CE, or a DCI of a certain format with certain fields set to specific values. The WTRU may receive an indication that it may update a prioritized set and/or report a new prioritized set. For example, if receiving a DCI indicating an uplink grant in a carrier, the WTRU may increase the priority of this carrier within a prioritized set (e.g., to the highest priority or to the highest priority after a primary carrier).

A prioritized set may be modified or updated based on a change of power headroom and/or a path loss estimate for at least one carrier. In examples, a WTRU may update a prioritized set if the WTRU triggers a power headroom report (PHR) due to power management (P-MPR), due to a change of a path loss, or another other PHR trigger.

A WTRU may start a prohibit timer when modifying a prioritized set. The WTRU may be allowed to modify a prioritized set if (e.g., only if) the prohibit timer is not running. The value of the prohibit timer may be pre-defined or configured by a higher layer (e.g., via RRC signaling).

For valid prioritized sets, a WTRU may determine a prioritized set from a configured set of valid prioritized sets. The set of valid prioritized sets may be configured by a higher layer (e.g., via RRC signaling) and may include a subset of possible combinations (e.g., all possible combinations) of prioritized sets that may be constructed from a set of configured carriers. A valid prioritized set may be associated with a label or a prioritized set identity. The configuration of a limited number of valid prioritized sets may be more efficient from a signaling perspective if the WTRU is not allowed to simultaneously transmit on certain combinations of carriers (e.g., even if the simultaneous transmission capability of the WTRU is not exceeded). In examples, such restriction may exist if simultaneous transmissions over a subset of carriers may cause radio problems (e.g., such as sensitivity degradation or spurious emissions).

For actions if updating a prioritized set, a WTRU may perform at least one of the following actions if modifying a prioritized set or if an uplink transmission is cancelled on at least one uplink carrier. The WTRU may trigger a power headroom report (PHR) for one or more (e.g., all) uplink carriers (e.g., all uplink carriers of a new prioritized set or all uplink carriers affected by the change of prioritized set). The WTRU may report multiple combinations of power headroom where combinations (e.g., each combination) may correspond to a specific subset of simultaneous uplink transmissions. In examples, the WTRU may report: a first combination of power headroom (PH) assuming transmissions on first and second uplink carriers only, a second combination of PH assuming transmissions on all uplink carriers, a third combination of PH assuming transmissions on second and third carriers only, and so on. The WTRU may report an indication of a new prioritized set. The report may include at least one of: an indication of a prioritized set identity (if configured); an indication of a UL carriers (e.g., each UL carrier or corresponding serving cell) of the new prioritized set; an indication of UL carriers that are no longer part of the new prioritized set; or an indication of UL carriers that are part of the new prioritized set but not part of the previous prioritized set. The WTRU may report an indication that an uplink transmission was cancelled on at least one uplink carrier. The report may be included in a MAC CE, an RRC message, or uplink control information on one of the prioritized uplink carriers. The WTRU may deactivate configured grants in uplink carriers (or corresponding serving cells) that are no longer part of the new prioritized set. The WTRU may activate configured grants in uplink carriers (or corresponding serving cells) that are part of the new prioritized set (e.g., but not part of the previous prioritized set).

A WTRU may apply at least one of the criteria (e.g., described herein) to determine the relative priorities of uplink transmissions and/or uplink carriers. Such criteria may be applied, for example, at least if applying a prioritization procedure (e.g., as described herein). The prioritization criteria may be one or more of: prioritization based on reception timing of a DCI; prioritization based on transmission timing of a latest transmission on the carrier; prioritization based on an explicit indication of priorities or of a prioritized set; prioritization based on a type of grant and priority configured for a grant; prioritization based on HARQ aspects; prioritization based on a type of physical channel, signal, or UCI; prioritization based on a type of serving cell, cell group, timing advance group, schedule SCell, or duplex; prioritization based on physical layer priority, logical channel priority, or data available for transmission; prioritization based on maximizing transmission opportunities over an application period, prioritization based on a property of transmission, prioritization based on a downlink path loss or quality; prioritization based on a power headroom; or prioritization based on a combination of prioritization criteria.

For prioritization based on the reception timing of a DCI, a WTRU may prioritize a first transmission or a first carrier over a second transmission or a second carrier if a DCI (e.g., a latest DCI) associated with a transmission on the first carrier is later than a DCI (e.g., a latest DCI) associated with a transmission on the second carrier. A reference time for determining the timing of a DCI may be the end of the last symbol of a PDCCH transmission carrying the DCI, the start of the first symbol of the PDCCH transmission carrying the DCI, or a transmission time (e.g., an upcoming transmission time). If the first and second DCI are received at the same time, the WTRU may apply an (e.g., additional) priority criterion such as a priority index that may be indicated in the DCI. The WTRU may (e.g., may also) consider a DCI that indicates a reception on a downlink carrier paired with or corresponding to the uplink carrier. In examples, only DCIs indicating certain types of transmissions (e.g., PUSCH transmissions) may be considered.

A WTRU may receive a first DCI indicating a dynamic grant on a first carrier and later a second DCI indicating a dynamic grant on a second carrier. The WTRU may prioritize between configured grants on the first and second carriers, and may prioritize the configured grant on the second carrier.

These techniques (e.g., described herein) may allow a network to control the uplink carriers that a WTRU may transmit on if configured grants or periodic SRS are configured on multiple uplink carriers.

For prioritization based on transmission timing of a latest transmission on the carrier, a WTRU may prioritize a first transmission or a first carrier over a second transmission or a second carrier if a latest transmission preceding the first transmission on the first carrier is later than the latest transmission preceding the second transmission on the second carrier. The reference time for determining the timing of an uplink transmission may be the end of the last symbol of the uplink transmission, the start of the first symbol of the uplink transmission, or a transmission time (e.g., an upcoming transmission time). This technique may be applicable (e.g., only applicable) to SRS transmissions or periodic SRS transmissions. In examples, this technique may consider a latest PUSCH transmission only or a latest PUSCH transmission indicated by DCI or corresponding to a dynamic grant only.

For prioritization based on an explicit indication of priorities or of a prioritized set, a WTRU may receive signaling (e.g., RRC signaling, DCI, etc.) indicating a priority level or an order associated with one or more uplink carriers (or corresponding serving cells). The WTRU may prioritize a first transmission on a first carrier over a second transmission on a second carrier if the priority indicated for the first carrier is higher than the priority indicated for second carrier.

A WTRU may receive signaling indicating a prioritized set as a set of uplink carriers or corresponding serving cells, or may receive a prioritized set indication. The signaling may be received via an RRC message, a MAC CE, or DCI. In examples, DCI may include at least one field indicating a prioritized set. The DCI may schedule transmissions on at least one serving cell. The DCI may include an indication of a prioritized set, in which case other fields may be set to pre-determined values to differentiate from DCI scheduling transmissions. A cyclic redundancy check (CRC) of the DCI may be scrambled by a specific radio network identifier (RNTI) configured or defined for the indication. The DCI may be a specific format and/or may be monitored on a specific search space.

A WTRU may assign a lowest priority to an uplink carrier (e.g., in a prioritized set) corresponding to a serving cell in response to receiving an indication for a dormant DL BWP for a corresponding group of serving cells. A WTRU may remove an uplink carrier from a prioritized set. A WTRU may restore the priority of an uplink carrier in response to receiving an indication for a non-dormant DL BWP for a corresponding group of serving cells.

For prioritization based on a type of grant and priority configured for a grant, a WTRU may prioritize a first transmission or a first carrier over a second transmission or a second carrier based on the type of grant corresponding to first transmission or the second transmission. In examples, a WTRU may prioritize a dynamic grant over a configured grant, or a configured grant type 2 over a configured grant type 1. A WTRU may prioritize transmissions or carriers based on a priority level indicated in a configured grant configuration (e.g., signaled by an RRC message or indicated by a MAC CE) or a priority level indicated for a dynamic grant.

A WTRU may prioritize a first transmission or a first carrier over a second transmission or a second carrier if the first transmission is indicated by a DCI and the second transmission is not indicated by a DCI (e.g., if the second transmission is semi-statically configured).

For prioritization based on HARQ aspects, a WTRU may prioritize a PUSCH transmission corresponding to a HARQ retransmission over a PUSCH transmission corresponding to a new transmission. This may increase the chance of successful transmission of a TB. The WTRU may prioritize a PUSCH transmission if it uses a HARQ process within a certain set of HARQ processes configured by a higher layer for a corresponding serving cell.

For prioritization based on a type of physical channel, signal, or UCI, a WTRU may prioritize transmissions based on the type of physical channels or signals associated with the transmissions. In examples, a WTRU may prioritize a PRACH transmission over a PUCCH transmission, a PUCCH transmission over a PUSCH transmission, or a PUSCH transmission over an SRS transmission. A WTRU may prioritize transmissions based on the presence and/or type of UCI carried by the transmissions (e.g. based on whether the UCI includes HARQ-ACK, a scheduling request (SR), channel state information (CSI), configured grant UCI (CG-UCI), or a link recovery request (LRR)). A WTRU may reuse a priority order already defined for transmission power reductions.

For prioritization based on a type of serving cell, cell group, timing advance group, schedule Scell, or duplex, a WTRU may prioritize a transmission or a carrier on a master cell group (MCG) over a transmission or a carrier on a secondary cell group (SCG). A WTRU may prioritize a transmission or a carrier on a primary cell (Pcell) or a special cell (SpCell) over a transmission or a carrier on other serving cells (e.g., such as an SCell). A WTRU may prioritize a transmission or a carrier on a primary timing advance group (pTAG) over a transmission or a carrier on a secondary timing advance group (sTAG). A WTRU may prioritize a transmission or a carrier on a PUCCH SCell or a PUCCH switching SCell over a transmission or a carrier on other serving cells. A WTRU may prioritize a transmission or a carrier corresponding to an SCell scheduling a PCell. A WTRU may prioritize a transmission or a carrier corresponding to a serving cell on which a WTRU may monitor DCI scheduling for multiple serving cells. A WTRU may prioritize a carrier used for uplink transmissions only (e.g., frequency division duplex (FDD) over a carrier used for both downlink and uplink (e.g., TDD), or vice versa. A WTRU may prioritize a transmission or a carrier on a first frequency band over a transmission or a carrier on a second frequency band (e.g., if the first frequency band has a higher priority than a second frequency band). The priority of a frequency band may be pre-defined or configured by a higher layer (e.g., via an RRC message). The priority may be such that frequency bands at higher frequencies may have a lower priority than frequency bands at lower frequencies.

For prioritization based on physical layer priority, logical channel priority, or data available for transmission, a WTRU may prioritize a set of uplink carriers based on grants on the corresponding serving cells and/or based on data available for transmission. In examples, a WTRU may prioritize a set of uplink carriers such that transmission of data of a highest priority (or of any priority) is maximized after logical channel prioritization. The WTRU may prioritize uplink carriers with grants of a highest priority index (e.g., as indicated by DCI or configured via an RRC message). In examples, the WTRU may prioritize uplink carriers with configured grants that have a highest priority based on at least one property of the configured grant configuration. The at least one property may include at least one of an explicit priority or a periodicity. The WTRU may prioritize a configured grant with a highest periodicity. In case data (e.g., all data) available for transmission may be multiplexed into a subset of grants on uplink carriers, the WTRU may select a subset of carriers such that the required number of transmissions is minimized.

For prioritization based on maximizing transmission opportunities over an application period, a WTRU may determine a prioritized set of uplink carriers for an application period such that a metric measured over the application period is minimized. In examples, a WTRU may determine a set of uplink carriers that may maximize transmission of data of the highest priority (or of any priority) over an application period, considering a switching time and/or a set of configured grant occasions (e.g., on uplink and/or flexible symbols) on carriers (e.g., each carrier) over the application period.

For prioritization based on a property of transmission, a WTRU may prioritize uplink carriers based on a property of a transmission configured on the carriers. In examples, such a property may include at least one of a subcarrier spacing, a bandwidth (e.g., number of resource blocks), a frequency band, a modulation order, a number of antenna ports, a priority index, a duration, etc. In examples, a WTRU may give priority to at least one of a lower subcarrier spacing, a lower bandwidth, a lower frequency band, a lower modulation order, a lower number of antenna ports, a higher priority index, or a lower duration.

For prioritization based on a downlink path loss or quality, a WTRU may prioritize uplink carriers for which a metric is maximized for a corresponding downlink carrier. Such a metric may serve as an estimate of the quality of connection for a carrier. In examples, a WTRU may prioritize an uplink carrier for which the signal strength and/or quality of reference signals associated with the coresets of a corresponding downlink carrier is maximized or is above a threshold. Such a quality may be measured by the q0 metric used for beam failure detection or by metrics such as CRI-RSRP or CRI-RSRQ. In examples, a WTRU may de-prioritize an uplink carrier if the WTRU performs a beam failure recovery procedure on a corresponding serving cell. In examples, a WTRU may prioritize an uplink carrier for which the path loss estimate used for power control is minimized.

For prioritization based on a power headroom, a WTRU may select a subset of carriers such that a total transmission power over the carriers is minimized, or such that a minimum or maximum PH across the carriers is maximized. This criterion may be applied between two candidate sets that have a same number of transmissions.

A WTRU may prioritize an uplink carrier for which a power headroom may be the highest (e.g., considering uplink carriers already prioritized). The power headroom determination may consider a potential maximum power reduction (MPR) that may be required if combining transmissions of the uplink carrier with already prioritized uplink carriers (e.g., considering possible radio frequency issues such as spurious emission and desensitization). A WTRU may de-prioritize an uplink carrier for which simultaneous transmission with already prioritized uplink carriers may not be supported considering the transmission power to be utilized on such carriers.

A WTRU may be configured to apply a reduced maximum power on a first prioritized uplink carrier to minimize a MPR with a potentially prioritized second carrier. Such reduction of a maximum power may be configured by a higher layer. In examples, an RRC message may configure a maximum transmission power on a first uplink carrier to be X dB below the maximum configured power of this carrier.

A WTRU may determine the priority of a carrier in a symbol or slot as a function of the direction (e.g., for an uplink, downlink, flexible, cross-duplex, etc.) associated with the symbol or slot. In examples, a carrier may be assigned a lowest priority level in time symbols or time slots that are downlink symbols or slots for this carrier. The direction may be provided by a higher layer (e.g., RRC signaling) and/or by a DCI such as a DCI format 2_0 that may provide a slot format indicator (SFI).

A WTRU may determine a prioritized set as a function of a time pattern. In examples, the WTRU may determine a first prioritized set for a first set of time units (e.g., slots or symbols) and a second prioritized set for a second set of time units. The first and second sets of time units and corresponding respective first and second prioritized sets may be configured by a higher layer (e.g., via RRC signaling). In examples, the first set of time units may correspond to downlink slots of one of the carriers and the second set of time units may correspond to uplink slots of the carrier.

A WTRU may determine the priority of a first transmission based on the priority of a second transmission in a same carrier. In examples, the priority for an SRS transmission may be the same as the priority of a PUSCH transmission that may be associated with the SRS transmission (e.g., by DCI) or that may be transmitted in the same time slot as the SRS transmission.

For prioritization based on a combination of prioritization criteria, a WTRU may apply more than one prioritization criteria with different levels of precedence. In examples, a WTRU may (e.g., may first) consider a criterion that may be based on the type of serving cells to prioritize an uplink carrier corresponding to a primary cell. The WTRU may (e.g., may then) consider another criterion that may be based on the reception of a latest DCI to prioritize between remaining uplink carriers.

A WTRU may (e.g., may first) prioritize according to a type of channels such that an uplink carrier with PUCCH (or PUSCH with UCI) is prioritized. The WTRU may (e.g., may then) prioritize remaining uplink carriers with dynamic grants and prioritize remaining uplink carriers with configured grants based on maximizing power headroom, reception of a latest DCI, or maximizing transmission of data.

In examples of dynamic prioritization, a WTRU may determine a set of configured or scheduled uplink transmissions in at least one carrier and/or over a time period (e.g., at a transmission time). The WTRU may determine if transmitting the set of uplink transmissions is possible by considering the WTRU's capability and a switching time. If transmitting the set of uplink transmissions is not possible, the WTRU may determine a subset of the uplink transmissions such that transmission of the subset is possible over the time period (e.g., at a transmission time). In examples, the subset of transmissions may be determined according to at least one priority rule. The priority rule may be to assign a higher priority to transmissions on an UL carrier indicated by a DCI (e.g., a DCI received later relative to a transmission time).

In an example of semi-dynamic prioritization, a WTRU may determine an initial prioritized set of uplink carriers. The WTRU may transmit on UL carriers based on the priority order of the prioritized set. The WTRU may modify the prioritized set based on at least one priority rule and/or event. In examples, a PCell may be given (e.g., always given) a highest priority (e.g., compared to an SCell or other cell types) or priority may be given based on the reception of DCI indicating a resource for a carrier sets (e.g., priority order may be determined based on latest received DCI relative to a transmission time). The WTRU may trigger a power headroom report if modifying the prioritized set.

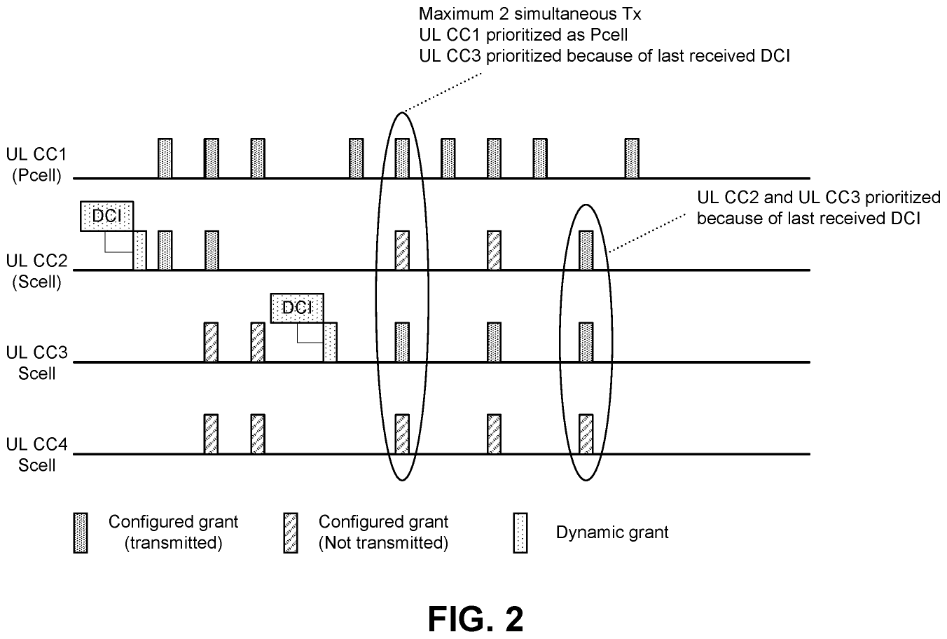

FIG. 2 illustrates an example of uplink carrier prioritization. A number of CGs and a number of carriers (e.g., four shown in FIG. 2) may be provided. A WTRU may receive configuration information indicating the number of CGs. As shown in FIG. 2, a first CG may be associated with a first carrier (e.g., UL CC1 as shown in FIG. 2) and a first cell type (e.g., a Pcell as shown in FIG. 2), a second CG may be associated with a second carrier (e.g., UL CC2 as shown in FIG. 2) and a second cell type (e.g., an Scell as shown in FIG. 2), a third CG may be associated with a third carrier (e.g., UL CC3 as shown in FIG. 2) and the second cell type, and a fourth CG may be associated with a fourth carrier (e.g., UL CC4 as shown in FIG. 2) and the second cell type. The WTRU may receive a number of PDCCHs. The number of PDCCHs may carry a number of UL grant DCIs (e.g., each of the number of PDCCHs may carry a respective UL grant DCI). As shown in FIG. 2, the WTRU may receive a first PDCCH carrying a first UL grant DCI associated with the second carrier and a second PDCCH carrying a second UL grant DCI associated with the third carrier.

A maximum number of carrier(s) (e.g., two as shown in FIG. 2) may be prioritized for transmission at a transmission time. The determination of which carrier(s) to prioritize may be based on a cell type the carrier(s) are associated with and/or may be based on when UL grant DCI(s) are received on the associated carrier(s) (e.g., relative to a transmission time and relative to when other UL grant DCI(s) are received). The WTRU may transmit a respective PUSCH transmission, via each prioritized carrier, using resource(s) associated with the respective CG of each prioritized carrier.

As shown in FIG. 2, the WTRU may determine to prioritize the first carrier and the third carrier at a first transmission time. As shown in FIG. 2, the determination to prioritize the first carrier may be based on the first cell type being the PCell type and the determination to prioritize the third carrier may be based on the second UL grant DCI being the last DCI received on the second carrier before the first transmission time. For a transmission time, the number of CGs (e.g., each of the CGs) may indicate resource(s) associated with carrier(s) (e.g., their respective carrier). As shown in FIG. 2, for the first transmission time, the first CG may indicate resource(s) associated with the first carrier, the second CG may indicate resource(s) associated with the second carrier, the third CG may indicate resource(s) associated with the third carrier, and the fourth CG may indicate resource(s) associated with the fourth carrier. As shown in FIG. 2, the first CG and the third CG may be prioritized over the second CG and the fourth CG for the second transmission time.

As shown in FIG. 2, at the first transmission time, the WTRU may transmit, via the first carrier, a first PUSCH transmission using resource(s) associated with the first CG and may transmit, via the third carrier, a second PUSCH transmission using resource(s) associated with the third CG. As shown in FIG. 2, based on the prioritization of the first carrier and the third carrier for the transmission at the first transmission time, the first transmission time may be limited to the first PUSCH transmission to be transmitted via the first carrier and the second PUSCH transmission to be transmitted via the third carrier. Based on the prioritization of the first carrier and the third carrier at the first transmission time, the WTRU may be limited to using resource(s) associated with the first carrier and the third carrier (e.g., and not using the resource(s) associated with the second carrier).

As shown in FIG. 2, the WTRU may determine to prioritize the second carrier and the third carrier for a transmission at a second transmission time. As shown in FIG. 2, the determination to prioritize the second carrier and the third carrier for the second transmission time may be based on the first UL grant DCI received on the second carrier and the second UL grant DCI received on the third carrier being the last two DCIs received before the second transmission time. As shown in FIG. 2, for the second transmission time, the second CG may indicate resource(s) associated with the second carrier, the third CG may indicate resource(s) associated with the third carrier, and the fourth CG may indicate resource(s) associated with the fourth carrier (e.g., and the first CG does not indicate a resource(s) associated with the first carrier). As shown in FIG. 2, the second CG and the third CG may be prioritized over the fourth CG for the second transmission time.

As shown in FIG. 2, at the second transmission time, the WTRU may transmit, via the second carrier, a third PUSCH transmission using resource(s) associated with the second CG and may transmit, via the third carrier, a fourth PUSCH transmission using resources(s) associated with the third CG. As shown in FIG. 2, based on the prioritization of the second carrier and the third carrier at the second transmission time, the second transmission time may be limited to the third PUSCH transmission to be transmitted via the second carrier and the fourth PUSCH transmission to be transmitted via the third carrier. Based on the prioritization of the second carrier and the third carrier at the second transmission time, the WTRU may be limited to using resource(s) associated with the second carrier and the third carrier (e.g., and not using resource(s) associated with the fourth carrier).

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the examples described herein consider LTE, LTE-A, New Radio (NR) or 5G specific protocols, it is understood that the examples described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-16. (canceled)

17. A wireless transmit/receive unit (WTRU), comprising:
a processor configured to:
receive configuration information indicating a plurality of configured grants (CGs), wherein the plurality of CGs comprise:
a first CG associated with a first cell type and a first carrier,
a second CG associated with a second cell type and a second carrier, and
a third CG associated with the second cell type and a third carrier;
receive a first physical downlink control channel (PDCCH) transmission carrying a first uplink (UL) grant downlink control information (DCI) associated with the second carrier;
receive a second PDCCH transmission carrying a second UL grant DCI associated with the third carrier;
determine to prioritize the first carrier and the third carrier of a plurality of carriers at a first transmission time, wherein the determination to prioritize the first carrier is based on the first cell type, and wherein the determination to prioritize the third carrier is based on a time the second UL grant DCI is received relative to the first transmission time; and
transmit at the first transmission time:
a first physical uplink shared channel (PUSCH) transmission, via the first carrier, using a resource associated with the first CG, and
a second PUSCH transmission, via the third carrier, using a resource associated with the third CG.

18. The WTRU of claim 17, wherein:
the first CG indicates a resource associated with the first carrier for the first transmission time,
the second CG indicates a resource associated with the second carrier for the first transmission time,
the third CG indicates a resource associated with the third carrier for the first transmission time, and
the first CG and the third CG are prioritized over the second CG.

19. The WTRU of claim 18, wherein:
the first carrier and the third carrier being prioritized over the second carrier limits the first PUSCH transmission to be transmitted via the first carrier at the first transmission time, and
the first carrier and the third carrier being prioritized over the second carrier limits the second PUSCH transmission to be transmitted via the third carrier at the first transmission time.

20. The WTRU of claim 19, wherein the resource associated with the second carrier for the first transmission time is not used.

21. The WTRU of claim 17, wherein the first cell type is a primary cell (PCell) type and the second cell type is a secondary cell (SCell) type, and wherein the determination to prioritize the first carrier is based on the first cell type being the PCell type.

22. The WTRU of claim 17, wherein the second UL grant DCI is a last DCI received before the first transmission time, and wherein the determination to prioritize the third carrier is based on the second UL grant DCI being the last DCI received before the first transmission time.

23. The WTRU of claim 17, wherein the processor is further configured to:
receive a fourth CG associated with the second cell type and a fourth carrier;
determine to prioritize the second carrier and the third carrier of the plurality of carriers at a second transmission time, wherein the determination to prioritize the second carrier for the second transmission time is based on reception of the first UL grant DCI relative to the second transmission time, and wherein the determination to prioritize the third carrier for the second transmission time is based on reception of the second UL grant DCI relative to the second transmission time; and
transmit at the second transmission time:
a third PUSCH transmission, via the second carrier, using a resource associated with the second CG, and
a fourth PUSCH transmission, via the third carrier, using a resource associated with the third CG.

24. The WTRU of claim 23, wherein:
the first UL grant DCI and the second UL grant DCI are last two DCIs received before the second transmission time, and
the determination to prioritize the second carrier and the third carrier for the second transmission time is based on the first UL grant DCI and the second UL grant DCI being the last two DCIs received before the second transmission time.

25. The WTRU of claim 24, wherein:
the first CG does not indicate a resource associated with the first carrier for the second transmission time,
the second CG indicates a resource associated with the second carrier for the second transmission time,
the third CG indicates a resource associated with the third carrier for the second transmission time, the fourth CG indicates a resource associated with the fourth carrier for the second transmission time, and
the second CG and the third CG are prioritized over the fourth CG for the second transmission time.

26. The WTRU of claim 25, wherein:
the second carrier and the third carrier being prioritized over the fourth carrier limits the third PUSCH transmission to be transmitted via the second carrier at the second transmission time,
the second carrier and the third carrier being prioritized over the fourth carrier limits the fourth PUSCH transmission to be transmitted via the third carrier at the second transmission time, and
the resource associated with the fourth carrier for the second transmission time is not used.

27. A method associated with a wireless transmit/receive unit (WTRU), the method comprising:
receiving configuration information indicating a plurality of configured grants (CGs), wherein the plurality of CGs comprise:
a first CG associated with a first cell type and a first carrier,
a second CG associated with a second cell type and a second carrier, and
a third CG associated with the second cell type and a third carrier;
receiving a first physical downlink control channel (PDCCH) transmission carrying a first uplink (UL) grant downlink control information (DCI) associated with the second carrier;
receiving a second PDCCH transmission carrying a second UL grant DCI associated with the third carrier;
determining to prioritize the first carrier and the third carrier of a plurality of carriers at a first transmission time, wherein the determination to prioritize the first carrier is based on the first cell type, and wherein the determination to prioritize the third carrier is based on a time the second UL grant DCI is received relative to the first transmission time; and
transmitting at the first transmission time:
a first physical uplink shared channel (PUSCH) transmission, via the first carrier, using a resource associated with the first CG, and
a second PUSCH transmission, via the third carrier, using a resource associated with the third CG.

28. The method of claim 27, wherein:
the first CG indicates a resource associated with the first carrier for the first transmission time,
the second CG indicates a resource associated with the second carrier for the first transmission time,
the third CG indicates a resource associated with the third carrier for the first transmission time, and
the first CG and the third CG are prioritized over the second CG.

29. The method of claim 28, wherein:
the first carrier and the third carrier being prioritized over the second carrier limits the first PUSCH transmission to be transmitted via the first carrier at the first transmission time, and
the first carrier and the third carrier being prioritized over the second carrier limits the second PUSCH transmission to be transmitted via the third carrier at the first transmission time.

30. The method of claim 29, wherein the resource associated with the second carrier for the first transmission time is not used.

31. The method of claim 27, wherein the first cell type is a primary cell (PCell) type and the second cell type is a secondary cell (SCell) type, and wherein the determination to prioritize the first carrier is based on the first cell type being the PCell type.

32. The method of claim 27, wherein the second UL grant DCI is a last DCI received before the first transmission time, and wherein the determination to prioritize the third carrier is based on the second UL grant DCI being the last DCI received before the first transmission time.

33. The method of claim 27, further comprising:
receiving a fourth CG associated with the second cell type and a fourth carrier;
determining to prioritize the second carrier and the third carrier of the plurality of carriers at a second transmission time, wherein the determination to prioritize the second carrier for the second transmission time is based on reception of the first UL grant DCI relative to the second transmission time, and wherein the determination to prioritize the third carrier for the second transmission time is based on reception of the second UL grant DCI relative to the second transmission time; and
transmitting at the second transmission time:
a third PUSCH transmission, via the second carrier, using a resource associated with the second CG, and
a fourth PUSCH transmission, via the third carrier, using a resource associated with the third CG.

34. The method of claim 33, wherein:
the first UL grant DCI and the second UL grant DCI are last two DCIs received before the second transmission time, and
the determination to prioritize the second carrier and the third carrier for the second transmission time is based on the first UL grant DCI and the second UL grant DCI being the last two DCIs received before the second transmission time.

35. The method of claim 34, wherein:
the first CG does not indicate a resource associated with the first carrier for the second transmission time,
the second CG indicates a resource associated with the second carrier for the second transmission time,
the third CG indicates a resource associated with the third carrier for the second transmission time, the fourth CG indicates a resource associated with the fourth carrier for the second transmission time, and
the second CG and the third CG are prioritized over the fourth CG for the second transmission time.

36. The method of claim 35, wherein:
the second carrier and the third carrier being prioritized over the fourth carrier limits the third PUSCH transmission to be transmitted via the second carrier at the second transmission time,
the second carrier and the third carrier being prioritized over the fourth carrier limits the fourth PUSCH transmission to be transmitted via the third carrier at the second transmission time, and
the resource associated with the fourth carrier for the second transmission time is not used.
